(19) United States
(12) Patent Application Publication
(10) Pub. No.: US 2008/0137879 A1
(43) Pub. Date: Jun. 12, 2008

(54) Wireless audio system

(76) Inventors: David L. Schwartz, Creve Coeur, MO (US); Jerome C. Fix, St. Louis, MO (US); Kevin John Roy McGowan, Saint Charles, MO (US)

Correspondence Address: CHASE LAW FIRM L.C, 4400 COLLEGE BOULEVARD, SUITE 130, OVERLAND PARK, KS, 66211, US

(21) Appl. No.: 11/789,295

(22) Filed: Apr. 24, 2007

Related U.S. Application Data
(60) Provisional application No. 60/794,398, filed on Apr. 24, 2006.

(51) Int. Cl. H04B 3/00

(52) U.S. Cl. 381/77

(57) ABSTRACT

A wireless audio system is provided for use with home audio speakers and includes a transmitter coupled to a stereo receiver and a plurality of speaker stands with built-in receivers. The speakers are placed on the speaker stands and coupled to the receivers.

### CROSS REFERENCE TO RELATED APPLICATION

This application claims the benefit of prior filed, co-pending application Ser. No. 60/794,398, filed Apr. 24, 2006, entitled WIRELESS AUDIO SYSTEM.

### THE FIELD

The present invention relates to an apparatus for the consumer electronics industry, and more particularly, to an integrated wireless audio system for use with audio speakers.

### BACKGROUND

Wireless speakers and headphones are known in the art. Wireless speakers and headphones typically operate in the frequency range of 902 MHz to 928 MHz. Generally a base unit is attached to a stereo output of an audio device such as a receiver. The base unit receives the stereo output signal from the receiver and converts it to an FM radio signal and broadcasts that signal. A receiver in the wireless speaker or headphone receives the radio signal from the base and converts it to an electrical signal which is sent to the speaker or headphone speaker where it is converted to sound. Both the base and speakers or headphones include a tuner to select a matching frequency between 902 MHz and 928 MHz. Other frequencies may be used such as 2.9 GHz and 5.8 GHz. These frequencies provide better range and clarity.

Other wireless technologies such as Bluetooth, WiFi and WiMAX, for example, are known for use with wireless headphones. Bluetooth enabled headphones or devices are designed to have a limited range so that they do not interfere with other Bluetooth devices. Bluetooth devices communicate on a frequency of between 2.402 GHz and 2.480 GHz. Other wireless devices operate in this frequency range such as baby monitors and cordless phones. However, Bluetooth transmitters use spread-spectrum frequency hopping to randomly change frequencies 1,600 times per second within the frequency range to avoid interference with other devices.

One problem with these systems is the wireless headphones or speakers are typically of poor audio quality, must be purchased separately, and are not adaptable for use with a consumer's existing speakers.

### SUMMARY

The present invention provides an apparatus to wirelessly connect a pair of standard speakers to an audio source. The apparatus includes a transmitter which is connected to the audio source such as a stereo receiver. The transmitter includes a tuner and broadcasts the audio signal over a range of predetermined frequencies which is received by two or more receivers. The receivers may include RCA or other speaker jacks, a volume control, frequency tuner, and indicator light, for example. The receivers may be integrated into a speaker stand or caddie.

### BRIEF DESCRIPTION OF THE DRAWINGS

FIG. 1 is a functional block diagram of the wireless audio system of the present invention.

FIG. 2 is a front elevation view of an illustration of a wireless receiver and speaker.

FIG. 3 is a side view of FIG. 2.

FIG. 4 is a front elevation view of a wireless speaker stand and speaker.

FIG. 5 is a side view of a wall mounted wireless audio receiver and speaker.

FIG. 6 is an illustration of the wireless audio system integrated into a television stand.

### DETAILED DESCRIPTION

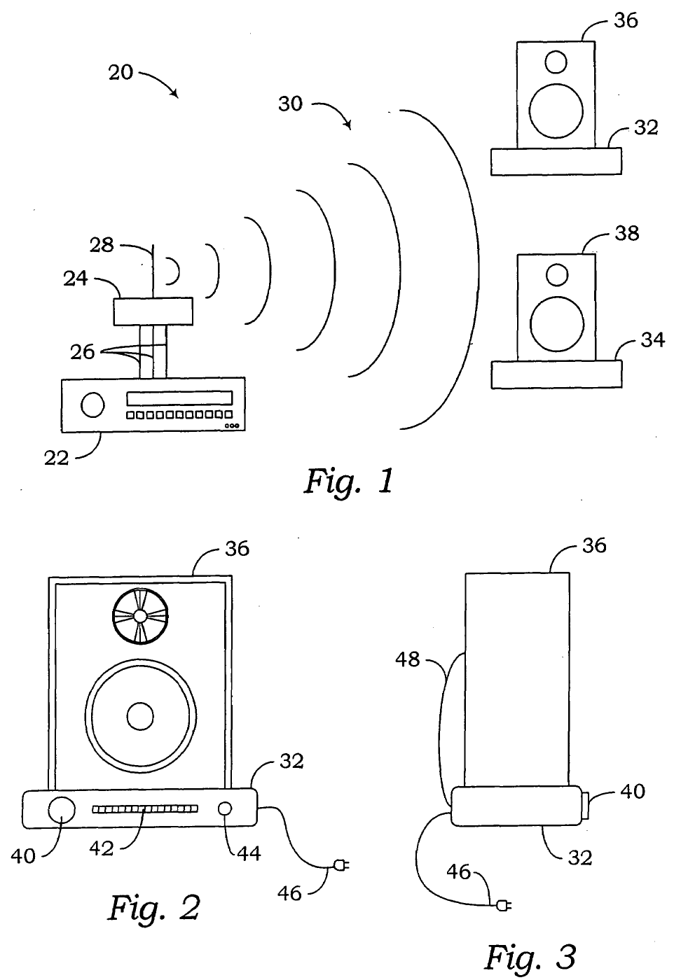

Referring to the FIG. 1, a wireless audio system of the present invention is generally indicated by reference numeral 20. Wireless audio system 20 is connected to an audio device 22 such as a stereo receiver. A wireless transmitter 24 is connected to a stereo output of the audio device 22 on one or more lines 26. The wireless transmitter 24 encodes the audio signal from the audio device 22 and broadcasts it via an antenna 28. The wireless transmitter 24 may include be

The wireless transmitter 24 may transmit a signal at a frequency of between 902 MHz and 928 MHz. Other frequencies may be used such as 2.9 GHz or 5.8 GHz, or Bluetooth, for example. The transmitted signal 30 is received by receivers 32 and 34 which decode the signal to produce an audio signal to left speaker 36 and right speaker 38.

Referring to FIGS. 2 and 3, receiver 32 may include a volume control 40, a signal strength indicator 42 and a power indicator 44. It should be understood that the description for receiver 32 is the same for receiver 34 and will not be repeated. Signal strength indicator 42 may be a multi-segment LED bar, graphical display or analog meter, for example, which provides a visual indication of the power of the signal received from the transmitter 24 (FIG. 1). Receiver 32 may be battery powered or may be powered through an AC power source 46. The audio signal is conveyed to the speaker 32 via line 48.

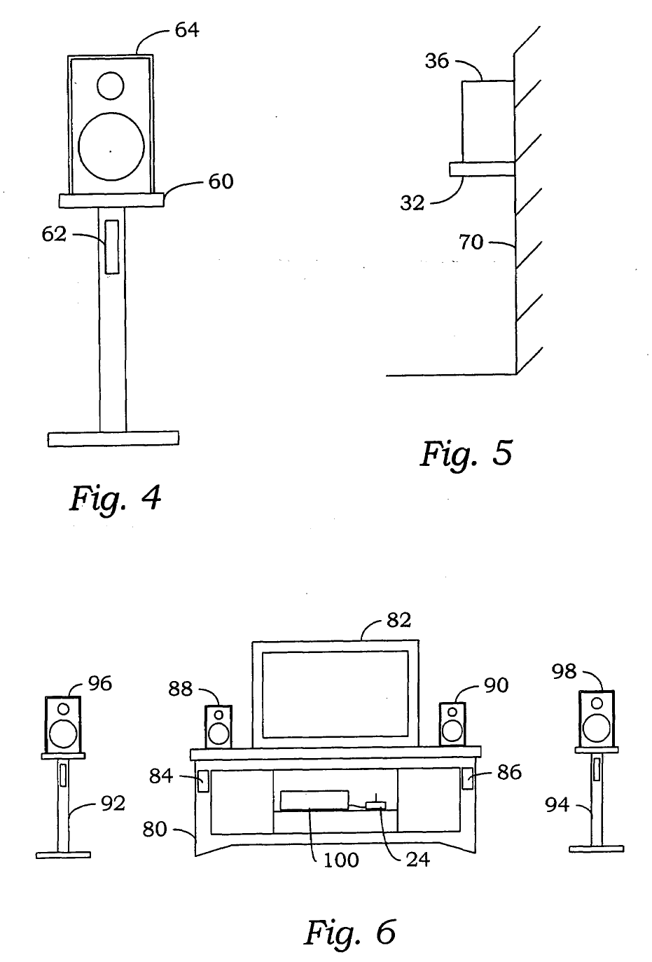

Referring to FIG. 4, the wireless audio system 20 of the present invention may be incorporated into a speaker stand 60. Speaker stand 60 includes a receiver 62 as discussed hereinabove for receiver 32 which is connected to a standard speaker 64. A volume control (not shown), signal strength indicator (not shown) and power indicator (not shown) may be incorporated into the speaker stand 60 as discussed hereinabove for receiver 32.

Referring to FIG. 5, receiver 32 may be mounted to a wall 70 and support a standard speaker 36. Standard mounting brackets (not shown) may be included to allow the user flexibility in locating the wireless receiver 32 anywhere in a room.

Referring to FIG. 6, an entertainment center 80 is illustrated supporting a television set 82 and includes wireless receivers 84 and 86 integrated into the entertainment center 80. The receivers 84 and 86 are connected to speakers 88 and 90, respectively, through audio cables (not shown). Additional wireless audio speaker stands 92 and 94 with speakers 96 and 98 may be present in the room and placed at various locations to enhance the listening enjoyment of the audio system. A receiver 100 may be placed on a shelf under the television set 82, along with a wireless transmitter 24. A separate wireless transmitter 24 may be used for each pair of speakers or a single wireless transmitter may include inputs to control two or more pairs of speakers. Utilizing the present invention with two or more pairs of speakers a user may enjoy surround sound without having to run wires throughout the room. Additionally, when a room is rearranged or the entertainment system is moved to another room or house, the wireless audio system may be easily set up.

It is to be understood that while certain forms of this invention have been illustrated and described, it is not limited thereto, except in so far as such limitations are included in the following claims and allowable equivalents thereof.

Having thus described the invention, what is claimed as new and desired to be secured by Letters Patent is:

1. A wireless audio system for use in combination with audio speakers and an audio output device, said wireless audio system comprising:
a transmitter coupled to the audio output device and having two inputs each for receiving a signal from the audio output device, said transmitter for transmitting wireless signals corresponding to said input signals,
at least two receivers each for receiving one of said transmitted wireless signals from said transmitter, and having a volume control, a signal strength indicator, a power indicator, a frequency selection control, and an audio output,
a pair of speaker stands, one each of said speaker stands for housing one of said receivers,
a pair of speakers, one each of said speakers for placement on one of said speaker stands and in direct communication with said audio output of said receiver housed in said speaker stand.

2. The wireless audio system of claim 1 wherein said transmitted wireless signals are of a frequency between 902 MHz and 928 MHz.

3. The wireless audio system of claim 1 wherein said transmitted wireless signals are of a frequency of about 2.9 GHz.

4. The wireless audio system of claim 1 wherein said transmitted wireless signals are of a frequency of about 5.8 GHz.

5. The wireless audio system of claim 1 wherein said transmitted wireless signals are Bluetooth compliant.

6. The wireless audio system of claim 1 wherein said signal strength indicator is a multi-segment LED bar.

7. The wireless audio system of claim 1 wherein said signal strength indicator is a graphical display.

8. The wireless audio system of claim 1 wherein said signal strength indicator is an analog meter.
